(19) United States
(12) Patent Application Publication
(10) Pub. No.: US 2012/0143691 A1
(43) Pub. Date: Jun. 7, 2012

(54) SYSTEM AND METHOD FOR PROVIDING USER-SPECIFIC ADVERTISEMENT ON BASIS OF M2M COMMUNICATION, AND MOBILE TERMINAL

(75) Inventors: Min Soo KIM, Daejeon (KR); In Hak Joo, Daejeon (KR); Moon Soo Lee, Daejeon (KR); Chung Ho Lee, Daejeon (KR); In Sung Jang, Daejeon (KR); Sung Woong Shin, Daejeon (KR)

(73) Assignee: Electronics and Telecommunications Research Institute, Daejeon (KR)

(21) Appl. No.: 13/307,340

(22) Filed: Nov. 30, 2011

(30) Foreign Application Priority Data
Dec. 2, 2010 (KR) 10-2010-0121992

(51) Int. Cl. G06Q 30/02

(52) U.S. Cl. 705/14.64

(57) ABSTRACT

Provided are a system and method for providing a user-specific advertisement on the basis of machine-to-machine (M2M) communication, and a mobile terminal. The method includes: receiving an advertising message broadcasted from at least one mobile terminal; extracting an advertisement according to a user situation using profile information set by a user of the mobile terminal; and presenting and displaying the extracted advertisement.

### CLAIM FOR PRIORITY

This application claims priority to Korean Patent Application No. 10-2010-0121992 filed on Dec. 2, 2010 in the Korean Intellectual Property Office (KIPO), the entire contents of which are hereby incorporated by reference.

### BACKGROUND

1. Technical Field

Example embodiments of the present invention relate in general to a system and method for providing a user-specific advertisement on the basis of machine-to-machine (M2M) communication and a mobile terminal, and more particularly, to an M2M communication-based mobile-user-specific advertising system and method that receive advertisements from neighboring objects on the basis of M2M communication, enable a user to select only information suitable for a situation of the user, and can relay received advertising information to other users in case of need.

2. Related Art

Traditionally, the Internet provides service for devices through Internet protocol (IP) access, and a mobile communication network provides voice-oriented service based on a mobile phone. On the other hand, M2M communication provides complex service enabling monitoring based on a sensor, etc. and measurement and control of equipment, and has a technological focus on mobility and trackability of a platform, compatibility and identifiability of information, and so on.

While ubiquitous sensor network (USN) technology is a physical concept of service based on various sensors, M2M communication based on a USN provides service-oriented technology in which objects become active objects by having communication means such as sensor nodes attached thereto so that connection is made between persons, between a person and an object, and between objects, and the persons and objects operate complexly among various networks.

In other words, M2M communication is service technology focusing on mobility, abstractness, messages, etc., rather than physical issues of a USN from a traditional sensor network service-oriented viewpoint. Thus, M2M communication concentrates on support for platform movement, a tracking function, quality maintenance, and mutual connectivity for complex service. In such M2M communication, service connection requires protocols that can be connected with each other, and the protocols focus on support for abstract information rather than physical information about a platform.

M2M communication applications have attracted great attention in recent years in the field of wireless communication. M2M communication applications are being used in the fields of medicine, agriculture, commerce, industry, distribution, electric power, etc. for various purposes, such as smart home, smart meters, quantitative analyzers, vehicle management, car insurance, and vending machines.

Such M2M applications can also be applied to a user-specific advertising service. In an existing customer-specific mobile advertising service, advertising information suitable for a user is provided by analyzing the user's location and profile information. At high cost, such a method maintains a location information server to collect location information about a user and find a location of the user in real time, keeps advertising information in an advertising server, and collects and maintains user profile information in a database. In other words, the existing method continuously manages location information about users in a location information server and advertising information provided by an advertiser, searches for advertising information suitable for locations of the users from a main center, and then provides the searched advertising information on the basis of the locations of the users. Also, the existing method involves obtaining individual agreements to collect personal location information and profile information and transmit advertising information to mobile terminals.

As described above, an existing mobile advertising service needs a solution to the problem of high cost for a server system constituted to provide a customer-specific advertising service and the problem of an advertising limitation that enables advertisements to be provided only to persons who have agreed on the advertising service.

### SUMMARY

Accordingly, example embodiments of the present invention are provided to substantially obviate one or more problems due to limitations and disadvantages of the related art.

Example embodiments of the present invention provide a machine-to-machine (M2M) communication-based mobile-user-specific advertising system and method that do not provide location and profile information about a user to an advertising server, and can provide a user-situation-specific advertising information service without a location information and profile server maintaining a huge amount of user location and profile information and a situation recognition server determining whether to provide advertising information suitable for a user situation on the basis of a location and profile of a user.

Example embodiments of the present invention also provide an M2M communication-based mobile-user-specific advertising system and method that provide a customized advertising information service to a user and enable the user to selectively receive advertising information using a broadcast-based advertising information provision method instead of transmitting the information to a specific advertisement receiver without a process of obtaining the user's agreement on receiving advertising information.

In some example embodiments, a user-specific advertisement providing method of a mobile terminal on the basis of M2M communication includes: receiving an advertising message broadcasted from at least one mobile terminal; extracting an advertisement according to a user situation using profile information set by a user of the mobile terminal; and presenting and displaying the extracted advertisement.

The method may further include retransmitting the extracted advertisement to at least one other mobile terminal.

The method may further include storing at least one of log information about the presented advertisement and log information about the advertisement retransmitted to the at least one other mobile terminal.

Extracting the advertisement according to the user situation may include filtering advertising information using user preference information set in advance by the user with regard to advertising information and real-time situation information about the user.

The user preference information may include information about at least one of a specific advertising field that the user wants to receive, a time when the user wants to receive an advertisement, and a spatial area where the user wants to receive an advertisement.

The real-time situation information about the user may include at least one of sensing information about weather and a surrounding environment of a user location, sensing information about a position and direction of the mobile terminal, and bio sensing information about the user.

The advertising message is edited by an advertisement editing terminal located at a place where advertisements are provided.

In other example embodiments, a system for providing a user-specific advertisement on the basis of M2M communication includes: an advertisement editing terminal located at a place providing advertisements, and configured to enable an advertiser to edit an advertising message; a wireless communication node configured to receive the advertising message from the advertisement editing terminal through a gateway and broadcast the advertising message to at least one mobile terminal; and a mobile terminal configured to receive the advertising message from the wireless communication node, extract an advertisement according to a user situation using profile information set by a user of the mobile terminal, and present and display the extracted advertisement.

The advertisement editing terminal may comprise: an advertisement generator configured to generate or modify advertisements; and an advertisement converter configured to convert advertising information generated by the advertisement generator into a packet.

The system may further include the gateway configured to maintain and manage connection of at least one wireless communication node, and transfer the advertising message received from the advertisement editing terminal to wireless communication nodes.

The wireless communication node may transmit the advertising message to at least one other wireless communication node using relay communication with the at least one other wireless communication node.

In other example embodiments, a mobile terminal communicates with an M2M-communication-based wireless communication node and provides an advertisement to a user. The mobile terminal is configured to receive the advertising message from the wireless communication node, extract an advertisement according to a user situation using profile information set by a user of the mobile terminal, and present and display the extracted advertisement.

The mobile terminal comprises: an advertisement receiver configured to receive an advertising message from the wireless communication node; a user profile configured to store user preference information including information about at least one of a specific advertising field that the user wants to receive, a time when the user wants to receive an advertisement, and a spatial area where the user wants to receive an advertisement; a user situation recognizer configured to filter advertising information received from the advertisement receiver using the user preference information set in advance by the user with regard to advertising information and real-time situation information about the user.

The mobile terminal further comprises; an advertisement presenting unit configured to present and display the extracted advertisement; and a retransmitter configured to retransmit the extracted advertisement to at least one other mobile terminal.

### BRIEF DESCRIPTION OF DRAWINGS

Example embodiments of the present invention will become more apparent by describing in detail example embodiments of the present invention with reference to the accompanying drawings, in which:

FIG. 1 illustrates a system for providing a machine-to-machine (M2M) communication-based advertising service according to an example embodiment of the present invention;

FIG. 2 is a block diagram of an advertisement provision stage according to an example embodiment of the present invention;

FIG. 3 is a block diagram of an advertisement reception stage according to an example embodiment of the present invention; and

FIG. 4 is a flowchart illustrating a method of providing an advertisement on the basis of M2M communication according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

The term “terminal” used herein may be referred to as a mobile station (MS), user equipment (UE), user terminal (UT), wireless terminal, access terminal (AT), subscriber unit, subscriber station (SS), wireless device, wireless communication device, wireless transmit/receive unit (WTRU), moving node, mobile, or other terms. Various example embodiments of a terminal may include a cellular phone, a smart phone having a wireless communication function, a personal digital assistant (PDA) having a wireless communication function, a wireless modem, a portable computer having a wireless communication function, a photographing apparatus such as a digital camera having a wireless communication function, a gaming apparatus having a wireless communication function, a music storing and playing appliance having a wireless communication function, an Internet home appliance capable of wireless Internet access and browsing, and also portable units or terminals having a combination of such functions, but are not limited to these.

A system for providing an advertisement on the basis of machine-to-machine (M2M) communication according to one aspect of the present invention includes an advertisement generator enabling an advertiser to personally edit and generate his/her own advertisement in real time, an advertisement converter that converts the generated advertisement into an appropriate format for wireless communication to efficiently transmit the advertisement by wireless communication, an advertisement transmitter consisting of a set of wireless communication nodes that broadcast advertising information to many unspecified persons by wireless communication, a wireless node manager in the form of a gateway for managing the set of wireless communication nodes, an advertisement receiver that receives the advertisement broadcast by the advertiser in a mobile terminal, a user situation recognizer that determines whether to present the received advertisement to the user using a module for recognizing a user's situation personally set by the user, an advertisement presenting unit that is presents an advertisement selected by situation recognition using the mobile terminal, and an advertisement retransmitter that determines whether to retransmit advertising information presented to the user to a neighboring user and retransmits the advertising information.

Hereinafter, example embodiments of the present invention will be described in detail with reference to the appended drawings.

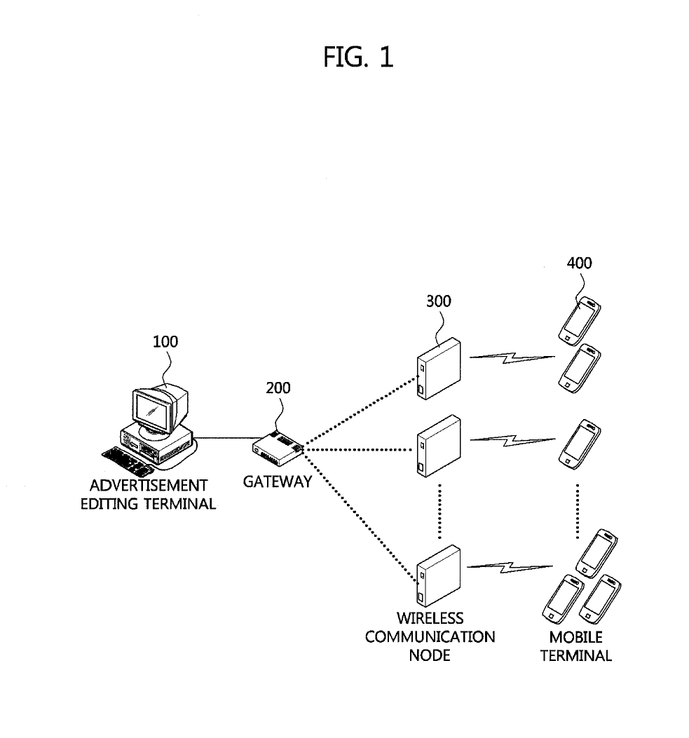

FIG. 1 illustrates a system for providing an M2M communication-based advertising service according to an example embodiment of the present invention.

Referring to FIG. 1, a system for providing a user-specific advertisement on the basis of M2M communication according to an example embodiment of the present invention includes an advertisement editing terminal 100 used by an advertisement, a gateway 200, wireless communication nodes 300, and mobile terminals 400 used by users. The advertisement editing terminal 100 is used by an advertiser who will provide an advertisement. The advertiser generates or modifies his/her own advertising message in real time using the advertisement editing terminal 100, and then transmits the advertising message to the gateway 200 that can be connected with the advertisement editing terminal 100 wirelessly or by wire. An example embodiment of the advertisement editing terminal 100 may be a personal computer (PC), which can be installed in a store providing advertisements. The advertisement editing terminal 100 is not limited to a PC, and may be any terminal capable of generating and modifying an advertising message. A place where the advertisement editing terminal 100 is installed may also be anywhere that the advertiser can use.

The gateway 200 maintains and manages connection with the plurality of wireless communication nodes 300 that are connected with the gateway 200 itself by near-field wireless communication. The gateway 200 serves, to directly transmit the advertising message received from the advertisement editing terminal 100 to the wireless communication nodes 300 or a mobile terminal that a user carries. In another example embodiment of the present invention, the gateway 200 may be directly connected with the advertisement editing terminal 100 by wire and installed on one side of a PC, or wirelessly connected with the advertisement editing terminal 100.

The wireless communication nodes 300 serve to transmit the advertising message to the neighboring mobile terminals 400 by near-field wireless communication. In particular, the wireless communication nodes 300 transmit the advertising message by a broadcast method. The wireless communication nodes 300 have a small size, and may be installed on any neighboring objects. The wireless communication nodes 300 may be installed on any objects, for example, a door, table, and window of a store that will provide advertisements, and there is no limitation in the number of the wireless communication nodes 300.

In an example embodiment of the present invention, the number of wireless communication nodes providing advertising information may be increased according to necessity, so that an advertising information message can be extensively provided in a large area around a store according to the type of advertising information and a situation.

The mobile terminals 400 serve to receive the advertising message transmitted by the wireless communication node 300, extract only advertisements suitable for user situations, display advertising messages, and rebroadcast the advertising messages to at least one other mobile terminal.

Here, users set their situations using their location, time, and profile information so that the mobile terminals 400 can extract only advertising messages that the users want. A mobile terminal according to an example embodiment of the present invention may be a mobile phone, smartphone, web pad, telematics terminal, etc. supporting various near-field communication networks, such as Bluetooth and ZigBee.

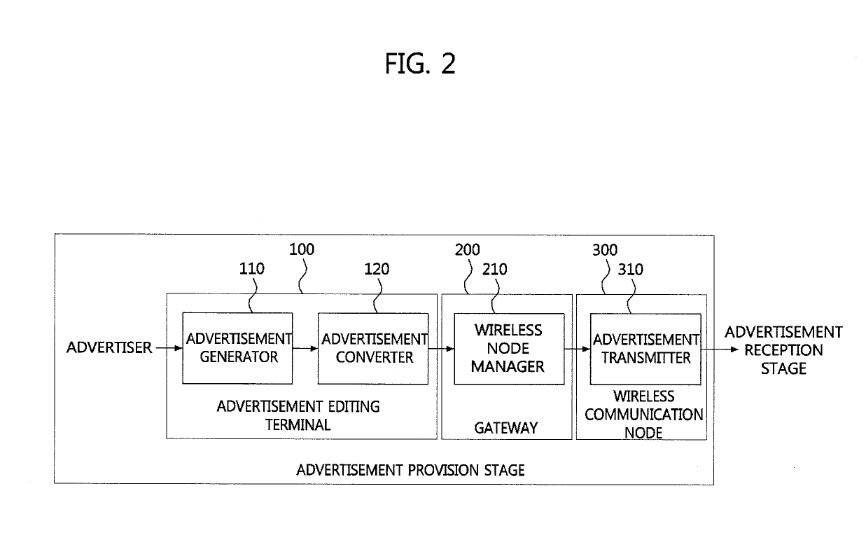

FIG. 2 is a block diagram of an advertisement provision stage according to an example embodiment of the present invention.

The advertisement provision stage according to an example embodiment of the present invention shown in FIG. 2 may include an advertisement editing terminal 100, a gateway 200, and a wireless communication node 300.

The advertisement editing terminal 100 may include an advertisement generator 110 and an advertisement converter 120, the gateway 200 may include a wireless node manager 210, and the wireless communication node 300 may include an advertisement transmitter 310.

The advertisement generator 110 enables an advertiser to generate a new advertisement by personally editing the advertisement, or to modify in real time an advertisement that has been served. Advertising information generated by the advertisement generator 110 in this way is transmitted to the advertisement converter 120.

The advertisement converter 120 serves to convert the advertising information generated by the advertiser into a wireless communication packet so as to transmit the advertising information to users by wireless communication. The advertising information converted into the wireless communication packet is transmitted to the wireless node manager 210 in the gateway 200.

The wireless node manager 210 is connected with the advertisement converter 120 of the advertisement editing terminal 100 wirelessly or by wire, and serves to transmit the advertising information converted into the wireless communication packet to the advertisement transmitter 310 of the wireless communication node 300 or an advertisement receiver 410 of a mobile terminal 400. In other words, the wireless node manager 210 may directly transmit advertising information in the form of a packet to a user of a mobile terminal, or transmit advertising information to a user of a mobile terminal through relay of a wireless communication node for further transmission of the advertising information.

In addition to transmission of advertising information in the form of a packet, the wireless node manager 210 serves to manage connection states of wireless communication nodes connected with the wireless node manager 210 itself.

The advertisement transmitter 310 of the wireless communication node 300 serves to transmit the advertising information in the form of a packet received from the wireless node manager 210 to the advertisement receiver 410 of the mobile terminal 400 by the broadcast method in a wireless environment. However, wireless communication nodes may directly provide advertising information to a mobile terminal by the broadcast method, or provide advertising information to a mobile terminal by relay communication between wireless communication nodes. Using such relay communication, the advertisement transmitter 310 may provide advertising information in an extensive area around a store.

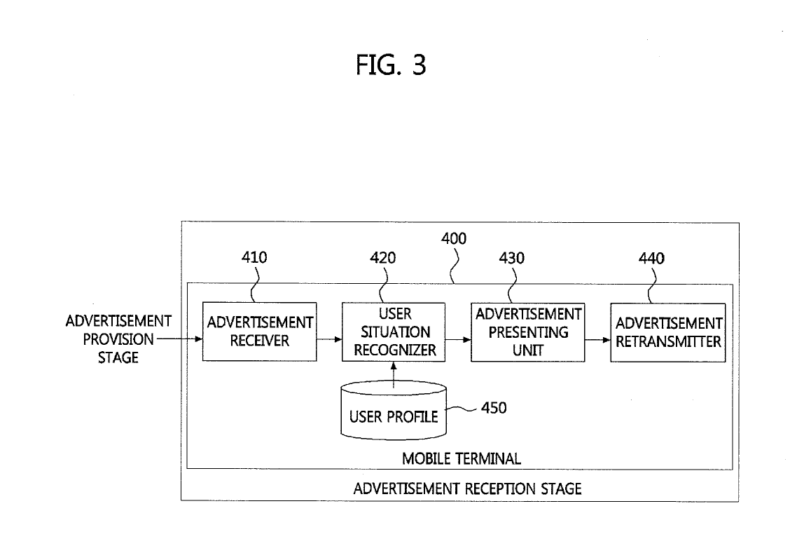

FIG. 3 is a block diagram of an advertisement reception stage according to an example embodiment of the present invention.

As shown in FIG. 3, the advertisement reception stage according to an example embodiment of the present invention may be a mobile terminal 400, which may include an advertisement receiver 410, a user situation recognizer 420, a user profile 450, an advertisement presenting unit 430, and an advertisement retransmitter 440.

The advertisement receiver 410 serves to receive advertising information in the form of a packet broadcast by an advertisement transmitter 310 and convert the advertising information in the form of a packet into original advertising information. Subsequently, the converted original advertising information is transmitted to the user situation recognizer 420.

Here, an example embodiment of the advertisement receiver 410 has a communication module capable of near-field communication with the advertisement transmitter 310.

The user situation recognizer 420 performs a situation recognition process for the advertising information transmitted from the advertisement receiver 410. During the situation recognition process, the transmitted advertising information is filtered using user preference information set in advance by a user with regard to advertising information and real-time situation information about the user. Here, the preference information set in advance by the user is stored in the user profile 450.

In an example embodiment of the present invention, the user preference information includes information about a specific advertising field that the user wants to receive, information about a time when the user wants to receive an advertisement, and information about a spatial area where the user wants to receive an advertisement.

Also, in an example embodiment of the present invention, the real-time situation information about the user may be sensing information about weather, such as temperature and humidity, and a surrounding environment, sensing information about a position and direction of the mobile device, bio sensing information about the user, such as a heart rate, and so on.

The user may personally edit such preference information in detail in the mobile terminal 400, and thereby may be provided with only advertising information that he/she wants through advertising information filtering based on the edited preference information. The user situation recognizer 420 provides a function of editing such user preference information.

To perform advertising information filtering based on the user preference information, the user situation recognizer 420 may collect real-time situation information, such as real-time location information and temporal information about the user, sensing information about weather and environment, and bio sensing information about the user, from the mobile terminal 400. The advertising information filtered by the user situation recognizer 420 is transmitted to the advertisement presenting unit 430.

The advertisement presenting unit 430 serves to display only the advertising information filtered on the basis of the preference information personally edited by the user to the user on the mobile terminal 400, and leaves log information about advertisement display.

Such log information may be used to provide a reward when the user visits a store providing the advertisement. While the advertisement is presented, a screen asking the user whether to retransmit the received advertising information is presented together, and the advertising information is transmitted to the advertisement retransmitter 440 when the user determines to retransmit the advertising information.

The advertisement retransmitter 440 retransmits the advertising information received from the advertisement presenting unit 430 in the same way as the advertisement transmitter 310 of a wireless communication node 300 by the broadcast method. When an acknowledgement (ACK) is received from advertisement receivers of mobile terminals carried by other users, log information about advertisement retransmission is left. Here, the log information about advertisement retransmission may be used to reward the user for advertisement retransmission when the user visits the store transmitting the advertisement.

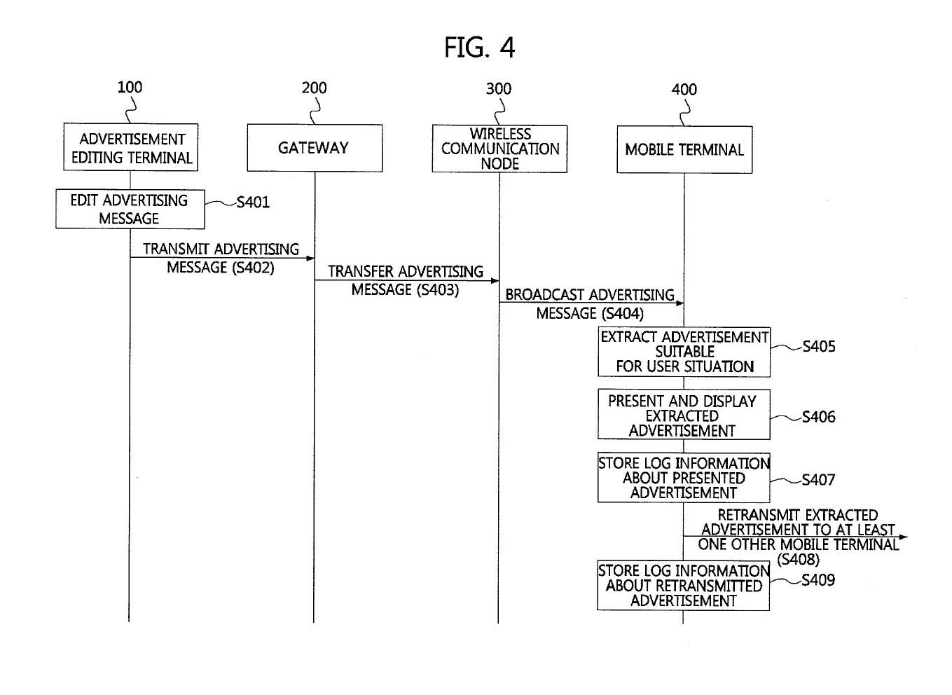

FIG. 4 is a flowchart illustrating a method of providing an advertisement on the basis of M2M communication according to an example embodiment of the present invention. In the method of providing an advertisement on the basis of M2M communication according to an example embodiment of the present invention, first, an advertiser edits an advertising message using an advertisement editing terminal 100 (S401). The edited advertising message is transmitted from the advertisement editing terminal 100 to a gateway 200 (S402). The gateway 200 receiving the advertising message transmits the advertising message to at least one wireless communication node 300 (S403). The wireless communication node 300 receiving the advertising message through the gateway 100 broadcasts the received advertising message to at least one mobile terminal 400 (S404).

The mobile terminal 400 receiving the advertising message from the at least one wireless communication node 300 extracts an advertisement suitable for a user situation using profile information set by a user of the mobile terminal 400 (S405). Here, the advertisement suitable for the user situation is extracted through advertising information filtering based on user preference information set in advance by the user with regard to advertising information and real-time situation information about the user. Subsequently, the mobile terminal 400 presents and displays the extracted advertisement (S406).

Here, the method of providing an advertisement according to an example embodiment of the present invention may selectively include a step of storing log information about the presented advertisement (S407). Also, the method may selectively include a step in which the mobile terminal 400 retransmits the extracted advertisement to at least one other mobile terminal (S408), and a step in which the mobile terminal 400 stores log information about the advertisement retransmitted to the at least one other mobile terminal (S409).

The above-described example embodiments of the present invention provide advertising information using a gateway installed in a store and a near-field broadcast communication network of a wireless communication node, thereby providing location-based advertising information to only users who are adjacent to the store and most likely to visit the store. Thus, the example embodiments of the present invention are much more cost-effective and time-efficient than a conventional system which manages a location information server and an advertising server in a centralized fashion to provide an advertising service based on a user location.

A conventional method continuously manages location information about users and advertising information provided by an advertiser in a location information server, searches a main center for advertising information suitable for locations of the users, and then provides the searched advertising information on the basis of the user locations. On the other hand, the example embodiments of the present invention can provide advertising information on the basis of a user location without continuously tracking locations of users, maintaining a location information server, and maintaining an advertising server in a main center.

Also, the example embodiments of the present invention enable a user to receive only advertising information that he/she wants and that is suitable for his/her situation using a user situation recognizer of a mobile terminal, and also to frequently change preference information using the mobile terminal. In other words, in the example embodiments of the present invention, a user can selectively receive only an advertising service that he/she wants.

Meanwhile, in the example embodiments of the present invention, advertising information selected by a user is retransmitted to other users according to selection of the user, and log information is left after retransmission of the advertising information, so that the user can be rewarded by an advertiser of the advertising information. Thus, a profitable effect is obtained by creating commercial value.

Finally, an advertiser can reduce advertising expenses by personally editing an advertisement and providing the advertisement using his/her system, and a user can reduce spam advertisements by receiving only advertisements that he/she wants.

According to example embodiments of the present invention, an advertiser can personally generate or modify an advertising message using an advertisement generator, and thus it is possible to provide an accurate advertising service in real time.

While the example embodiments of the present invention and their advantages have been described in detail, it should be understood that various changes, substitutions and alterations may be made herein without departing from the scope of the invention.

What is claimed is:

1. A user-specific advertisement providing method of a mobile terminal on the basis of machine-to-machine (M2M) communication, comprising:
receiving an advertising message broadcasted from at least one wireless communication node;
extracting an advertisement according to a user situation using profile information set by a user of the mobile terminal; and
presenting and displaying the extracted advertisement.

2. The method of claim 1, further comprising retransmitting the extracted advertisement to at least one other mobile terminal.

3. The method of claim 1, further comprising storing at least one piece of log information about the presented advertisement.

4. The method of claim 1, wherein extracting the advertisement according to the user situation includes filtering advertising information using user preference information set in advance by the user with regard to advertising information and real-time situation information about the user.

5. The method of claim 4, wherein the user preference information includes information about at least one of a specific advertising field that the user wants to receive, a time when the user wants to receive an advertisement, and a spatial area where the user wants to receive an advertisement.

6. The method of claim 4, wherein the real-time situation information about the user includes at least one of sensing information about weather and a surrounding environment of a user location, sensing information about a position and direction of the mobile terminal, and bio sensing information about the user.

7. The method of claim 1, wherein the advertising message is edited by an advertisement editing terminal located at a place where advertisements are provided.

8. A system for providing a user-specific advertisement on the basis of to machine-to-machine (M2M) communication, comprising:
an advertisement editing terminal located at a place where advertisements are provided, and configured to enable an advertiser to edit an advertising message;
a wireless communication node configured to receive the advertising message from the advertisement editing terminal through a gateway and broadcast the advertising message to at least one mobile terminal; and
a mobile terminal configured to receive the advertising message from the wireless communication node, extract an advertisement according to a user situation using profile information set by a user of the mobile terminal, and present and display the extracted advertisement.

9. The system of claim 8, the advertisement editing terminal comprising:
an advertisement generator configured to generate or modify advertisements; and
an advertisement converter configured to convert advertising information generated by the advertisement generator into a packet.

10. The system of claim 8, further comprising the gateway configured to maintain and manage connection of at least one wireless communication node, and transfer the advertising message received from the advertisement editing terminal to wireless communication nodes.

11. The system of claim 8, wherein the wireless communication node transmits the advertising message to at least one other wireless communication node using relay communication with the at least one other wireless communication node.

12. A mobile terminal communicating with at least one wireless communication node and providing advertisements to a user, wherein the mobile terminal is configured to receive the advertising message from the at least one wireless communication node, extract an advertisement according to a user situation using profile information set by a user of the mobile terminal, and present and display the extracted advertisement.

13. The mobile terminal of claim 12, comprising:
an advertisement receiver configured to receive the advertising message in the form of a packet broadcasted by the wireless communication node and convert the advertising message back into original advertising information;
a user profile configured to store user preference information including information about at least one of a specific advertising field that the user wants to receive, a time when the user wants to receive an advertisement, and a spatial area where the user wants to receive an advertisement; and
a user situation recognizer configured to filter the advertising information received from the advertisement receiver using the user preference information set in advance by the user with regard to advertising information and real-time situation information about the user.

14. The mobile terminal of claim 13, further comprising:
an advertisement presenting unit configured to present and display the extracted advertisement, and store a log of the presented advertising information; and
a retransmitter configured to retransmit the extracted advertisement to at least one other mobile terminal.

15. The mobile terminal of claim 13, wherein the real-time situation information about the user includes at least one of sensing information about weather and a surrounding environment of a user location, sensing information about a position and direction of the mobile terminal, and bio sensing information about the user.
